(19) United States
(12) Patent Application Publication
(10) Pub. No.: US 2026/0185738 A1
(43) Pub. Date: Jul. 2, 2026

(54) Heat Recovery Air Handling Unit

(71) Applicant: Limited Liability Company Ventilation Systems, Kyiv (UA)

(72) Inventors: Oleksandr Stanislavovych Klapishevskyi, Kyiv (UA); Anatolii Mykhailovych Tsiomyk, Kyiv (UA)

(21) Appl. No.: 19/431,047

(22) Filed: Dec. 23, 2025

(30) Foreign Application Priority Data
Dec. 26, 2024 (UA) 2024 06219

(51) Int. Cl. F24F 13/22

(52) U.S. Cl. CPC F24F 13/222

(57) ABSTRACT

An exemplary heat recovery air handling unit includes an external module with external supply and external exhaust grilles, an inner module with plate recuperator, with internal intake and internal exhaust grilles, with a filter, with an inlet chamber of the exhaust duct, with an outlet chamber of the exhaust duct, with an inlet chamber of the intake duct, with an outlet chamber of the intake duct and a partition between the inlet and outlet chambers of the exhaust and intake ducts, respectively. Fans form counter air flows, with at least one fan located in the inlet chamber of the intake duct, and with at least one fan is located in the outlet chamber of the exhaust duct. A plate recuperator, such as a plate heat exchanger, provides heat transfer and physical separation between the counter airflows. The heat recovery air handling unit may include a condensate removal system.

### CROSS-REFERENCE TO RELATED APPLICATIONS

This application claims the benefit of priority to Ukrainian utility model application UA 2024 06219, filed 26 Dec. 2024, which is herein incorporated by reference in its entirety.

### FIELD OF THE INVENTION

The invention generally relates to ventilation equipment, and more particularly to supply and exhaust ventilation systems with heat recovery, and may be installed within domestic and special-purpose premises.

### BACKGROUND

The state of the art discloses various technical solutions, shapes, and constructions designed for natural ventilation of both residential and commercial buildings.

The drive to find optimal ventilation system solutions is motivated by the aim to design buildings in a way that ensures maximum energy efficiency in the building. However, increasing the energy efficiency coefficient of a building proportionally reduces the natural self-regulation of the indoor climate. In other words, in such buildings, due to the use of central heating, the operation of numerous household appliances, and other modern technological factors, significant indoor air drying occurs. This, in turn, creates favorable conditions for the development of allergic diseases and respiratory complications or illnesses.

In spring and summer, energy-efficient buildings poorly remove excess humidity, hindering natural air circulation inside the premises and thus creating favorable conditions for the growth of mold and harmful microorganisms.

The above statements have long been known. Therefore, for example, in many developed countries, medical institutions recommend frequent ventilation of premises. Most countries implement regulations governing air exchange systems.

Ventilation is mainly achieved by opening windows, thereby allowing natural air circulation inside the premises. However, ventilation solely through window opening causes many inconveniences. In particular, during winter, an open window significantly cools the room due to its surface area, while in summer it causes overheating. As a result, this leads to considerable energy consumption to maintain acceptable and comfortable working and living conditions. Consequently, continuous efforts are being made to develop and enhance ventilation systems.

A known heat recovery air handling unit is described in Ukrainian utility model 146223, dated Jan. 27, 2021, which describes a recuperator with air ducts, a fan, and a heat exchanger, interconnected and mounted in the wall of a room between its external and internal surfaces. Two straight-through concentric cylinders are installed in the opening between the external and internal surfaces of the room, and between them, on the outer surface of the inner cylinder, an Ω-shaped (in cross-section) corrugated heat exchanger is fixed. Additionally, on the inner surface of the cylinder, opposite to each other, external and internal fans are installed. The system openings are equipped with corresponding external and internal covers, where the internal cover is provided with an intake air grille and an internal air outlet slot with an air diffuser. The external cover is additionally equipped with a condensate drain opening extending beyond the plane of the external wall surface, an air intake grille, and a corresponding grille for the exhaust of internal air.

The drawbacks of this heat recovery air handling unit include a low degree of air heat exchange efficiency. When air passes along the heat exchange surface of the corrugated heat exchanger, the presence of cut-outs in the troughs of the heat exchanger reduces the heat exchange area. The low level of air exchange performance arises because the airflows in the system are unbalanced.

Additionally, a drawback is the lack of resistance to wind loads. Since the outer module is of an open type, it does not provide wind protection for the exhaust duct and leads to the risk of the unit freezing at sub-zero temperatures.

Since it is structurally impossible to install full-fledged heaters and filtering elements, and the power supply unit is located in the room module, as a result, additional heating of the recuperator is not provided. The design of the heat exchanger causes excessive condensation and leads to possible freezing of the system.

Another known heat recovery air handling unit is described in EP4417886A1, dated Aug. 21, 2024, which is designed for installation into an external wall of a building. That unit has an inner module and an adjacent heat exchange module, which consists of a cylindrical corrugated heat exchanger with a multitude of heat exchange air channels arranged along the symmetry axis of the heat exchanger. These air channels have identical cross-sections and are adjacent to each other, forming a continuous corrugated volume of heat exchange segments. The first separator and the second separator are provided for separating and directing the exhaust and supply airflows in opposite directions within the heat exchange air ducts. The first and second separators are attached to the heat exchanger on both of its end surfaces and mounted along the symmetry axis of this heat exchanger. The first fan and the second fan, whose housings are adjacent to the first and second separators respectively, are installed at the ends of the separators facing away from the heat exchanger. The axis of one fan is arranged parallel to, but not coaxial with, the axis of the other fan.

The drawbacks of this heat recovery air handling unit are a low degree of air heat exchange efficiency, low air exchange performance. A heat exchanger design causes excessive condensation, which may limit the use and operation of the system, or insufficiently effective condensate removal from the system, which may lead to the system freezing during cold seasons.

A known heat recovery air handling unit is described as set forth at https://zehnder.com.ua/decentralized-ventilation/comfoair70, which describes an external module with external intake and external exhaust grilles, inner module with plate recuperator, with internal intake and internal exhaust grilles, with a filter, with an inlet chamber of the exhaust duct, with an outlet chamber of the exhaust duct, with an inlet chamber of the intake duct, with an outlet chamber of the intake duct and a partition between the inlet and outlet chambers of the exhaust and intake ducts, respectively, with fans that form counter air flows, with the fan located in the inlet chamber of the intake duct, where the fan is located in the outlet chamber of the exhaust duct.

The drawbacks of that known heat recovery air handling unit are as follows:
there is no condensate removal system, for example: condensate collection tank, a pump for removing condensate outside the system, or a channel for removing condensate outside the system, which leads to excessive accumulation of condensate and potential freezing of the system in countries with cold climates;
there is no heater in the inlet chamber of the intake duct for preheating the air, which is necessary to prevent condensation;
there is no heating element in the outlet chamber of the intake duct for post-heating the air, which is used to ensure a comfortable intake air temperature in countries with cold climates;
there are no filters in the in-wall part of the inner module, which results in polluted air and insects entering the system and the premise;
complexity of the unit's design for its maintenance during operation.

### SUMMARY

An objective of the present invention is to create a heat recovery air handling unit, in which:
a high level of air heat exchange efficiency is achieved through the placement of a counterflow or crossflow plate recuperator in the inner module;
a high level of air exchange performance is ensured due to the structural arrangement of the fans.
airflow mixing is prevented by means of a partition placed in the inner module between the inlet and outlet chambers of the exhaust and intake ducts.
maximum efficient heat transfer from the heater for pre-heating the air and the heater for post-heating is achieved by means of their full placement in the inlet chamber of the intake duct and the outlet chamber of the intake duct, respectively.
excessive accumulation of condensate and subsequent freezing of the system in countries with cold climates is prevented due to a condensate removal system, namely: a condensate collection tank and a channel for removing condensate outside the system, or a channel for removing condensate outside the system, or a pump for removing condensate outside the system, or a pump and channel for removing condensate outside the system, or an evaporator.
ingress of polluted air and insects into the system and premises is prevented due to the presence of filters.
maintenance of the unit during operation is improved due to easy removal of the module with the fans, dampers, valve and filter installed in it.

The stated objective may be achieved as follows. A heat recovery air handling unit contains an external module with external supply and external exhaust grilles, inner module with plate recuperator, with internal intake and internal exhaust grilles, with a filter, with an inlet chamber of the exhaust duct, with an outlet chamber of the exhaust duct, with an inlet chamber of the intake duct, with an outlet chamber of the intake duct and a partition between the inlet and outlet chambers of the exhaust and intake ducts, respectively, with fans that form counter air flows, with the first fan located in the inlet chamber of the intake duct, and the second fan is located in the outlet chamber of the exhaust duct. The system may contain a condensate removal system, and the inner module may include an on-wall and an in-wall part, where the in-wall part contains a module with fans installed in it.

In one of the embodiments that solves the stated problem, a module with the installed fans in the heat recovery air handling unit is removable.

Another embodiment that solves the stated problem is that in the heat recovery air handling unit, the module with the installed fans additionally contains a mechanical damper and/or a gravity valve.

In yet another of the embodiments that solves the stated problem, a module with the installed fans in the heat recovery air handling unit additionally contains at least one filter.

The stated problem is also solved by the fact that in the heat recovery air handling unit, the inlet chamber of the intake duct contains a heater for pre-heating the air.

In yet another of the embodiments that solves the stated problem, in the heat recovery air handling unit, the outlet chamber of the intake duct contains a heater for post-heating the air.

In another of the embodiments that solves the stated problem, in the heat recovery air handling unit, the in-wall part of the inner module has an external thermal insulation shell.

Additionally, in another of the embodiments that solves the stated problem, in the heat recovery air handling unit, the condensate removal system is the channel for removing condensate outside the system.

Also, in another of the embodiments that solves the stated problem, in the heat recovery air handling unit, the condensate removal system is the condensate collection tank and the channel for removing condensate outside the system.

In another embodiment that solves the stated problem, in the heat recovery air handling unit, the condensate removal system is the pump for removing condensate outside the system.

In yet another embodiment that solves the stated problem, in the heat recovery air handling unit, the condensate removal system is the pump and the channel for removing condensate outside the system.

As one more embodiment that solves the stated problem, in the heat recovery air handling unit, the condensate removal system is the condensate collection tank with an ultrasonic evaporator.

In one of the embodiments that solves the stated problem, in the heat recovery air handling unit, there is also an air humidity sensor.

Also, according to another embodiment that solves the stated problem, depending on the wall thickness, the length of the in-wall part of the inner module is regulated with the help of the external thermal insulation shell during installation.

The heat recovery air handling unit described herein differs from the documents described above in at least the following aspects:
An easy-to-remove module with fans, dampers, valve and filter, which improves the maintenance of the unit during operation without dismantling the system itself.
Full-fledged heater for pre-heating the air and heater for post-heating the air, located in the inlet chamber of the intake duct and outlet chamber of the intake duct, the presence of which ensures the most efficient heat transfer from them.
A condensate removal system, which prevents excessive condensate accumulation and subsequent freezing of the system in countries with cold climates.
Filters, which prevent the ingress of polluted air and insects into the system and premises.

As a result of using the invention described herein, a heat recovery air handling unit is created, which ensures a high degree of heat exchange efficiency, a high degree of air exchange performance and a simplified maintenance of the unit during operation without dismantling the system itself.

### BRIEF DESCRIPTION OF THE DRAWINGS

FIG. 1 is a perspective view of a heat recovery air handling unit.

FIG. 2 is a perspective cutaway view of the heat recovery air handling unit of FIG. 1.

FIG. 3 is a perspective cutaway view of the heat recovery air handling unit of FIG. 1, showing additional components and depicting the movement of warm and cold air therethrough.

FIG. 4 is a perspective view of the heat recovery air handling unit of FIG. 1, showing a removable module removed therefrom.

FIG. 5 is a perspective view of the removable module of FIG. 4.

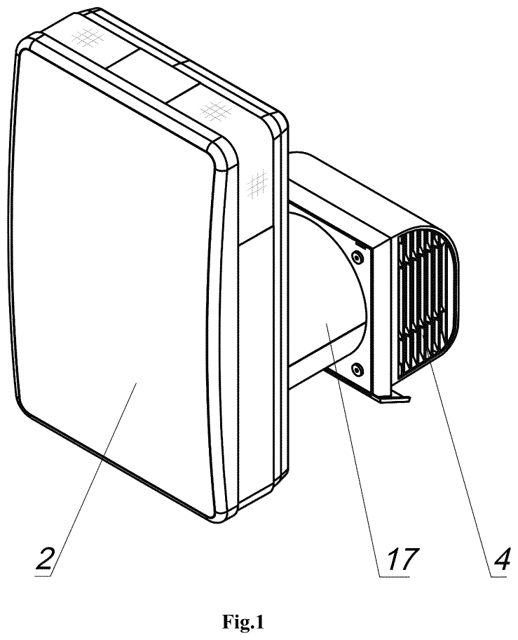

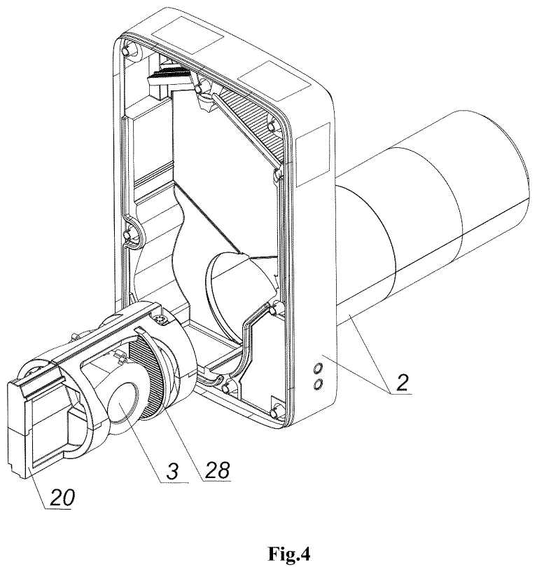

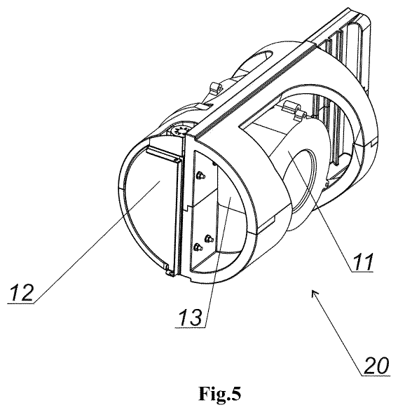

In FIGS. 1-5, the following reference numbers are associated with the listed items:
1—heat recovery air handling unit
2—inner module
2A—on-wall part of the inner module
2B—in-wall part of the inner module
3, 11—fans
4—external module
5—plate recuperator
6—inlet chamber of the exhaust duct
7—outlet chamber of the exhaust duct
8—inlet chamber of the intake duct
9—outlet chamber of the intake duct
10—partition
12—mechanical damper
13—gravity valve
14—air pre-heating element
15—post-heating element
16, 28—filter
17—external thermal insulation shell
18—channel for removing the condensate
19—condensate collection tank
20—module
21—internal intake grille
22—internal exhaust grille
23—external intake grille
24—external exhaust grille
25—ultrasonic evaporator
26—pump for removing the condensate.

### DETAILED DESCRIPTION

Referring to FIGS. 1-5, a heat recovery air handling unit (1) includes inner (2) and outer (4) modules. The inner module (2) includes on-wall (2A) and in-wall (2B) parts. The in-wall part (2B) of the inner module (2) is surrounded, at least partially, by an external thermal insulation shell (17), which is used to reduce heat transfer to the surrounding structures (wall), and improves the system's noise cancelling characteristics, as is shown in FIG. 1. Additionally, the in-wall part (2B) of the inner module (2) contains a module (20) with fans (3), (11), a mechanical damper (12) and/or a gravity valve (13), and at least one filter (28) installed therein.

The module (20) may be removable, so that it can undergo maintenance from the front side of the heat recovery air handling unit (1) (also referred to as the system (1)), such as after removing a service panel. As a result, routine maintenance work on the system (1) can be carried out from inside a room serviced by the system (1), without dismantling the system (1) itself, and without having to go outside to do so. This may be an advantage where the system (1) is utilized on a higher floor of a multistory building.

The heat recovery air handling unit (1) includes a condensate removal system. In some embodiments, the condensate removal system is a condensate collection tank (19) and a channel (18) for removing condensate outside the system (1). In some embodiments, the condensate removal system is a channel (18) for removing condensate outside the system (1). In some embodiments, the condensate removal system is a pump (26) for removing condensate outside the system (1). In some embodiments, the condensate removal system is a pump (26) and a channel (18) for removing condensate outside the system (1). In some embodiments, the condensate removal system is a condensate collection tank (19) with an ultrasonic evaporator (25) adjacent thereto.

The inlet chamber of the intake duct (8) may contain a heater (14) for pre-heating the air. This heater (14) is used for pre-heating the air to combat condensation. The outlet chamber of the intake duct (9) contains a heater (15) for post-heating the air. The post-heating element (15) is used to ensure a comfortable intake air temperature in countries with cold climates. The heater (14) may be a resistance heater or any other suitable structure and/or mechanism that generates heat.

A filter (16) may be utilized in the on-wall part (2A) of the inner module (2), in the inlet chamber of the exhaust duct (6) directly in front of a plate recuperator (5). In the in-wall part (2B) of the inner module (2), there may be a filter (28) located in the module (20), in the inlet chamber of the intake duct (8). The filters (16), (18) protect the plate recuperator (5) of counterflow or crossflow type, and radial fans (3), (11) from contaminated air and insects entering them and the premises. The filters (16), (28) may be treated with an antibacterial agent.

The on-wall part (2A) of the inner module (2) has an internal supply grille (21) and an internal exhaust grille (22), and the external module (4) has an external supply grille (23) and an external exhaust grille (24).

Depending on the wall thickness, the length of the in-wall part (2B) of the inner module (2) is regulated with the help of the external thermal insulation shell (17) during installation, by cutting off a part of it from the street side with any cutting tool.

In addition, the heat recovery air handling unit (1) may be additionally equipped with at least one air humidity sensor (not shown), which is able to control the humidity of the supply and/or exhaust air, depending on the task. In some embodiments, at least one air humidity sensor is positioned in the exhaust duct (6). In some embodiments, at least one air humidity sensor is positioned in the intake duct (8).

The plate recuperator (5) is a heat exchanger, such as a plate heat exchanger that includes a specific number of thin profiled plates that are arranged parallel to and spaced apart from each other, forming a solid pack with separated hermetic channels for the movement of two air streams towards each other between the plates. The two air streams may be referred to as counter air flows. The condensate removal system is in gas contact with at least one of said counter air flows.

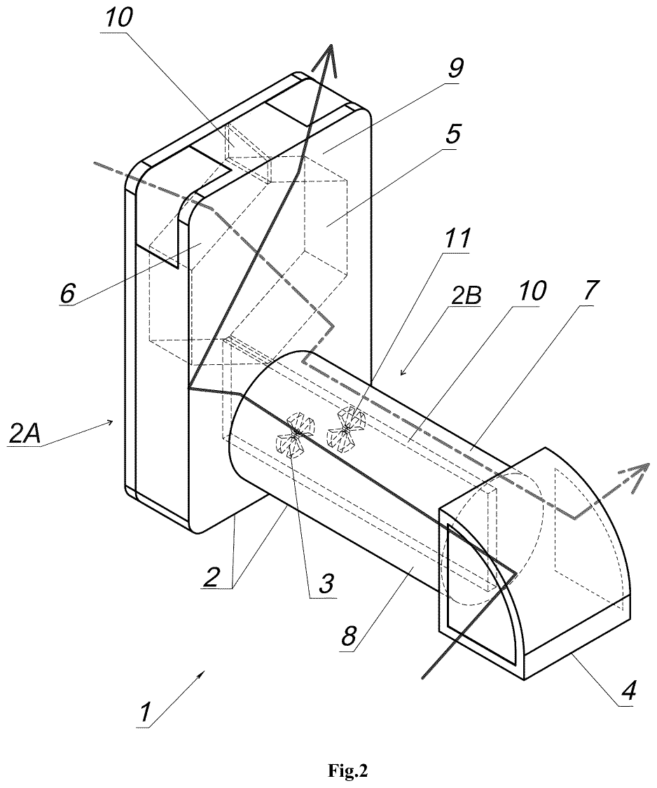

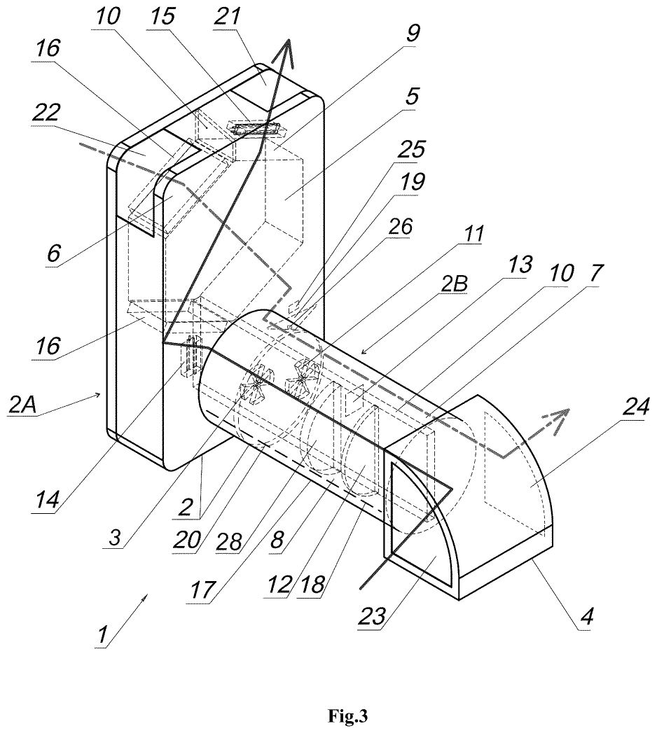

FIGS. 2-3 schematically show the flow of warm air (dashed line) and the flow of cold air (solid line) through the heat recovery air handling unit (1).

The heat recovery air handling unit (1) operates as follows. After the heat recovery air handling unit (1) is switched on, the exhaust (11) and intake (3) fans are activated, initiating air exchange within the system (1). Warm, used air from the premises enters the internal intake grille (22) of the on-wall part (2A) of the inner module (2), then flows through the inlet chamber of the exhaust duct (6), and then enters the plate recuperator (5), where it heats the latter. After that, upon exiting the plate recuperator (5), the air enters the in-wall part (2B) of the inner module (2), then flows into the outlet chamber of the exhaust duct (7), then flows through the exhaust fan (11), than enters the outer module (4) and is discharged outside through the external exhaust grille (24).

Simultaneously with that movement of warm air, cold fresh air is supplied. Cold air from outside, through the external intake grille (23), enters the external module (4), then passes through the in-wall part (2B) of the inner module (2), then the inlet chamber of the intake duct (8), then passes through the filter (28) and the intake fan (3), then flows into the on-wall part (2A) of the inner module (2), where the plate recuperator is located (5). The cold air, before entering the plate recuperator (5), may be warmed by the heater (14) for pre-heating the air. Upon exiting the plate recuperator (5), the fresh but warmed air passes through the outlet chamber of the intake duct (9), than passes through the internal intake grille (21) and enters the premises. In countries with cold climates, the fresh but warmed air when exiting the plate recuperator (5) may enter the outlet chamber of the intake duct (9) and may be warmed to a higher temperature by the heater for post-heating (15) the air, and then enters the premises passing through the internal intake grille (21).

A partition (10) is placed between the inlet chamber of the intake duct (8) and the outlet chamber of the exhaust duct (7), as well as between the inlet chamber of the exhaust duct (6) and the outlet chamber of the intake duct (9), to prevent the mixing of exhaust and intake airflows. As a result of airflows through the plate recuperator during the operation of the heat recovery air handling unit (1), heat exchange occurs between the warm and cold air, while the airflows do not mix.

The examples provided only illustrate and do not limit the possible implementations of the present invention.

The operation of the heat recovery air handling unit (1) may be carried out using a control panel on the side panel of the system, via an infrared remote control, and/or through a mobile application over a wireless network, such as but not limited to a Wi-Fi network.

The heat recovery air handling unit (1) is designed with the possibility of easy disconnection from the ventilation shaft of the in-wall part (2B) of the inner module (2), which contains an easy-to-remove module with fans, mechanical damper, gravity valve and filter installed in it, which simplifies its maintenance during repair or preventive servicing.

What is claimed is:

1. A heat recovery air handling unit (1), comprising:
an outer module (4) with an outer intake grille (23) and an outer exhaust grille (24);
an inner module (2) with a plate recuperator (5) positioned therein, with an inner intake grille (21) and an inner exhaust grille (22), with a filter (16), with an inlet chamber of an exhaust duct (6), with an outlet chamber of an exhaust duct (7), with an inlet chamber of an intake duct (8), with an outlet chamber of an intake duct (9); and
a partition (10) between said inlet chamber of said intake duct (8) and said outlet chamber of said exhaust duct (7), respectively, with fans (3), (11), forming counter air flows, wherein said fan (3) is located in said inlet chamber of said intake duct (8), and said fan (11) is located in said outlet chamber of said exhaust duct (7); and
a condensate removal system in gas contact with at least one of said counter air flows;
wherein said inner module (2) comprises an on-wall part (2A) and an in-wall part (2B), and wherein said in-wall part (2B) contains a module (20) with said fans (3), (11) installed therein.

2. A heat recovery air handling unit according to claim 1, wherein said module (20) is removable.

3. A heat recovery air handling unit according to claim 1, wherein said module (20) further comprises at least one of a mechanical damper (12) and a gravity valve (13).

4. A heat recovery air handling unit according to claim 1, wherein said module (20) further comprises at least one filter (28).

5. A heat recovery air handling unit according to claim 1, further comprising a heater (14) for pre-heating the air, said heater (14) located in the inlet chamber of the intake duct (8).

6. A heat recovery air handling unit according to claim 1, further comprising a heater (15) for post-heating the air, said heater (15) located in the outlet chamber of the intake duct (9).

7. A heat recovery air handling unit according to claim 1, further comprising an external thermal insulation shell (17) surrounding, at least partially, the in-wall (2B) part of the inner module (2).

8. A heat recovery air handling unit according to claim 1, wherein said condensate removal system is a channel (18) for removing condensate outside the system (1).

9. A heat recovery air handling unit according to claim 1, wherein said condensate removal system is a condensate collection tank (19) and a channel (18) for removing condensate outside the system (1).

10. A heat recovery air handling unit according to claim 1, wherein said condensate removal system is a pump (26) for removing condensate outside the system (1).

11. A heat recovery air handling unit according to claim 1, wherein said condensate removal system is a pump (26) and a channel (18) for removing condensate outside the system (1).

12. A heat recovery air handling unit according to claim 1, wherein said condensate removal system is a condensate collection tank (19) with an ultrasonic evaporator (25) adjacent said condensate collection tank (19).

13. A heat recovery air handling unit according to claim 1, further comprising an air humidity sensor positioned in said exhaust duct (6).

14. A heat recovery air handling unit according to claim 1, further comprising an air humidity sensor positioned in said intake duct (8).

15. A heat recovery air handling unit according to claim 1, wherein a length of said in-wall part (2B) of the inner module (2) is regulated with the help of said external thermal insulation shell (17) during installation.

16. A heat recovery air handling unit according to claim 1, wherein said condensate removal system is positioned in said on-wall part (2A) of said inner module (2).
